(19) United States
(12) Patent Application Publication
(10) Pub. No.: US 2026/0042584 A1
(43) Pub. Date: Feb. 12, 2026

(54) RECYCLABLE HIGH MOISTURE BARRIER FILM

(71) Applicant: AMCOR FLEXIBLES NORTH AMERICA, INC., Neenah, WI (US)

(72) Inventors: Ross K. GRUETZMACHER, Neenah, WI (US); Marcelo B. ELIAS, Appleton, WI (US); Melissa K. COOLICH, Hortonville, WI (US)

(21) Appl. No.: 19/100,672

(22) PCT Filed: Aug. 25, 2022
(86) PCT No.: PCT/US2022/041583

§ 371 Date: Feb. 3, 2025

(51) Int. Cl. B65D 65/02; B32B 27/08; B32B 27/32

(52) U.S. Cl. CPC B65D 65/02; B32B 27/08; B32B 27/32; B32B 2250/03; B32B 2250/242; B32B 2255/10; B32B 2255/205; B32B 2307/702; B32B 2307/72; B32B 2307/7265; B32B 2439/00

(57) ABSTRACT

Described herein are recyclable packaging films comprising an unoriented multilayer film including a first layer comprising a polymer selected from the group consisting of a cyclic olefin copolymer, an ethylene vinyl alcohol copolymer or a polyamide, a second layer comprising a polyethylene having a density in a range of from 0.89 g/cm³ to 0.94 g/cm³, and a third layer comprising a high-density polyethylene. The unoriented multilayer film has a first surface comprising the first layer, upon which a vapor deposited layer is located. The total composition of the recyclable packaging film includes greater than 90% polyethylene-based polymers, by weight. Also described herein are packages that incorporate the recyclable packaging films.

### TECHNICAL FIELD

This disclosure is related to packages and recyclable film structures including a vapor deposited barrier layer which exhibit high moisture barrier.

### BACKGROUND

In the field of flexible packaging, laminations of metalized biaxially oriented polypropylene (BOPP) films are one of the standard low cost, high moisture barrier solutions. However, the current recycling systems in place in the United States and some other countries does not accept flexible films containing BOPP unless it can be proven that the film has a minimal effect on the re-processability of the overall packaging film.

Films containing high levels of polyethylene (i.e., >80% PE, by weight) can also be designed to provide good moisture barrier. High-density polyethylene (HDPE) materials can effectively reduce the moisture vapor transmission rate (MVTR). However, to reach a MVTR suitable for products sensitive to moisture (or loss of moisture) the amount of HDPE required may be significant and the films become bulky (i.e., thick) and difficult to process on most packaging equipment. Moisture barrier performance of polyethylene films can also be boosted by adding barrier coatings such as thin metal layers. However, the industry has not achieved polyethylene-based packaging films that have the combination of runnability and high moisture barrier as compared to the metalized BOPP films. The need exists for a recyclable packaging film having high moisture barrier properties.

### SUMMARY

There remains a need for a recyclable film structure having high polyethylene content and excellent moisture barrier properties. The recyclable film structures disclosed herein unexpectedly achieve these properties. These recyclable films are useful for packaging applications wherein the product requires protection from exposure to moisture (i.e., limit moisture gain) or protection from loss of moisture (i.e., limit moisture loss).

An embodiment of the recyclable packaging film comprises: (1) an unoriented multilayer film comprising a first surface comprising a first layer comprising a polymer selected from the group consisting of a cyclic olefin copolymer, an ethylene vinyl alcohol copolymer or a polyamide, the first layer having a thickness in a range of from 5% to 15% of a thickness of the unoriented multilayer film, a second layer comprising a polyethylene having a density in a range of from 0.89 g/cm³ to 0.94 g/cm³, the second layer directly adjacent to the first layer, the second layer having a thickness in a range of from 5 to 60% of the thickness of the unoriented multilayer film, and a third layer comprising a high-density polyethylene, the third layer directly adjacent to the second layer, the third layer having a thickness in a range of from 15% to 75% of the thickness of the unoriented multilayer film, (2) a vapor deposited layer located on the first surface; and (3) a total composition including greater than 90% polyethylene-based polymers, by weight.

In some embodiments the unoriented multilayer film further comprises a second surface opposite the first surface, the second surface comprising a fourth layer comprising a polyethylene polymer.

In some embodiments the recyclable packaging film further comprises a sealing layer attached to the unoriented multilayer film.

In some embodiments the sealing layer is patterned.

In some embodiments the vapor deposited layer comprises a metal and the recyclable packaging film has an optical density in a range of from 1.5 to 4.5, measured by ASTM D1003.

In some embodiments the vapor deposited layer comprises an inorganic oxide.

In some embodiments the first layer comprises in a range of from 90% to 100% by weight of the cyclic olefin copolymer, the ethylene vinyl alcohol copolymer or the polyamide.

In some embodiments the polymer of the first layer is fully amorphous.

In some embodiments the polymer of the first layer is a cyclic olefin copolymer comprising a glass transition temperature in a range of from 60° C. to 180° C.

In some embodiments the first layer is free from or substantially free from particulates.

In some embodiments the first layer is free from or substantially free from polyethylene polymers.

In some embodiments the polyethylene comprised in the second layer has a density in a range of from 0.910 g/cm³ to 0.940 g/cm³.

In some embodiments the third layer comprises in a range of from 90% to 100% high density polyethylene, by weight.

In some embodiments the high-density polyethylene is bimodal with regard to molecular weight.

In some embodiments the high-density polyethylene has a melt flow rate greater than 1 g/10 min, as measure ASTM D1238-10.

In some embodiments the high-density polyethylene is nucleated.

In some embodiments the total composition includes a non-polyethylene content in a range of from 5% to 15%, by weight.

In some embodiments the recyclable packaging film has a curl of less than 90%, according to the X-Cut Curl Test.

In some embodiments the recyclable packaging film also has an oriented polyethylene-based film attached to the vapor deposited layer of the unoriented multilayer film.

Some embodiments of the recyclable packaging film comprise of: (1) an unoriented multilayer film comprising a first surface comprising a first layer comprising 100% of a cyclic olefin copolymer, by weight, the first layer having a thickness in a range of from 5% to 15% of a thickness of the unoriented multilayer film, a second layer comprising a polyethylene having a density in a range of from 0.89 g/cm³ to 0.94 g/cm³, the second layer directly adjacent to the first layer, the second layer having a thickness in a range of from 5 to 30% of the thickness of the unoriented multilayer film, and a third layer comprising greater than 95% of a high-density polyethylene by weight, the third layer directly adjacent to the second layer, the third layer having a thickness in a range of from 50% to 75% of the thickness of the unoriented multilayer film, (2) a vapor deposited layer located on the first surface, (3) an oriented polyethylene film attached to the vapor deposited layer, (4) a patterned sealing layer attached to the unoriented multilayer film on a second surface, the second surface opposite of the first surface, and (5) a total composition including greater than 90% polyethylene-based polymers, by weight.

Some embodiments of the recyclable packaging film comprise of: (1) an unoriented multilayer film comprising: a first surface comprising a first layer comprising 100% of a cyclic olefin copolymer, by weight, the first layer having a thickness in a range of from 5% to 15% of a thickness of the unoriented multilayer film, a second layer comprising a polyethylene having a density in a range of from 0.89 g/cm³ to 0.94 g/cm³, the second layer directly adjacent to the first layer, the second layer having a thickness in a range of from 40 to 60% of the thickness of the unoriented multilayer film, and a third layer comprising greater than 95% of a high-density polyethylene by weight, the third layer directly adjacent to the second layer, the third layer having a thickness in a range of from 15% to 45% of the thickness of the unoriented multilayer film, (2) a vapor deposited layer located on the first surface, (3) an oriented polyethylene film attached to the vapor deposited layer, (4) sealing layer attached to the unoriented multilayer film on a second surface, the second surface opposite of the first surface, and (5) a total composition including greater than 90% polyethylene-based polymers, by weight.

Also disclosed herein are embodiments of packages comprising a recyclable packaging film.

### BRIEF DESCRIPTION OF THE DRAWINGS

The disclosure may be more completely understood in consideration of the following detailed description of various embodiments of the disclosure in connection with the accompanying drawings, in which:

FIG. 1 is a perspective view of an embodiment of a package including a recyclable packaging film;

FIG. 2 is a cross-sectional view of an embodiment of a recyclable packaging film;

FIG. 3 is a cross-sectional view of an embodiment of an unoriented multilayer film;

FIG. 4 is a cross-sectional view of an embodiment of an unoriented multilayer film;

FIG. 5 is a cross-sectional view of an embodiment of a recyclable packaging film;

FIG. 6 is a top view of an embodiment of a recyclable packaging film;

FIG. 7 is a perspective view of an embodiment of a package including a recyclable packaging film;

FIG. 8 is a cross-sectional view of an embodiment of a recyclable packaging film;

FIG. 9 is a perspective view of an embodiment of a package including a recyclable packaging film;

FIG. 10A is a top view of the template used for the X-Cut curl test;

FIG. 10B is a top view of a film sample used for the X-Cut curl test;

FIGS. 10C and 10D are side views of the film sample of FIG. 10B;

FIG. 10E is a plan view of the measuring device used for the X-Cut curl test; and

FIG. 10F is a perspective view of the execution of an X-Cut curl test.

The drawings show some but not all embodiments. The elements depicted in the drawings are illustrative and not necessarily to scale, and the same (or similar) reference numbers denote the same (or similar) features throughout the drawings.

### DETAILED DESCRIPTION

Disclosed herein are recyclable packaging films having high polyethylene content and previously unobtainable high moisture vapor barrier (i.e., low moisture vapor barrier transmission) with respect to the relative thin structures. Also disclosed are packages and packaged products that benefit from the recyclability of the packaging film as well as performance properties such as runnability and high barrier. Examples of package formats that may utilize the recyclable packaging films disclosed herein include, but are not limited to, horizontal or vertical form-fill-seal, tray/cup and lidding, pouches or bags, gusseted pouches and sachets. Packaged products that may benefit from using a recyclable packaging film as described herein include, but are not limited to, consumer products, such as laundry and dish detergents, confectionary products, baked goods, cereal or grain containing products, dairy or dairy containing products, chips or crackers, powdered products such as baby formula.

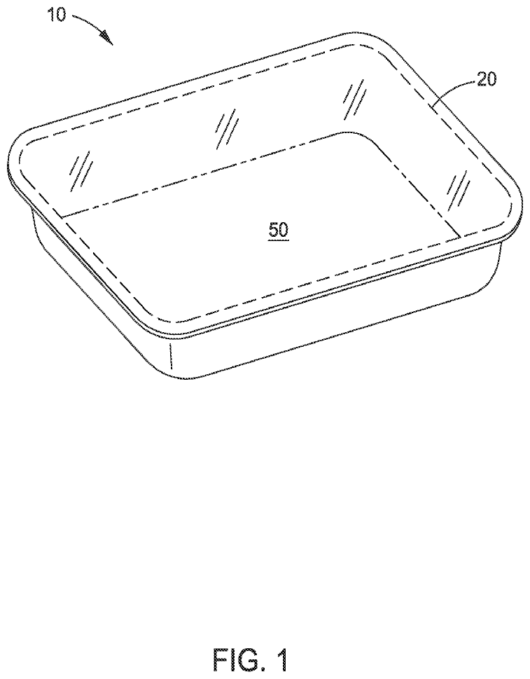

An embodiment of a package 10 that includes a recyclable packaging film 50 as described herein is shown in FIG. 1. This configuration includes a tray and a lidding component that is made from the recyclable packaging film 50. The recyclable packaging film 50 is attached to the tray by a seal 20 at the perimeter of the opening of the tray. The seal 20 may be made by any known process including, but not limited to, heat sealing, cold sealing, induction sealing, or ultrasonic sealing. The package 10 shown in FIG. 1 includes one continuous seal 20, but other package formats may include more than one seal to form the package. Other package formats may include only the recyclable packaging film or may include other package components such as zippers. The benefit of the high moisture barrier of the recyclable packaging film is best recognized when the package is hermetically sealed, thus preventing moisture transmission through any openings in the seal. Specific package formats and packaging applications will be described in combination with specific embodiments of the recyclable packaging film.

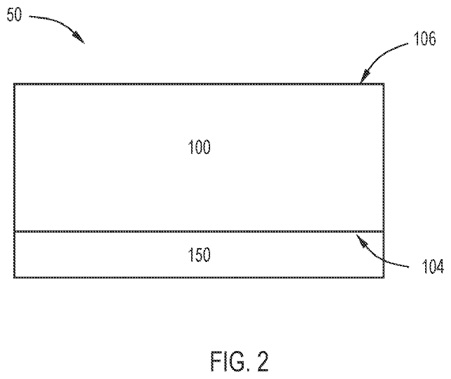

An embodiment of a recyclable packaging film 50 has a general structure as shown in FIG. 2. The recyclable packaging film 50 includes an unoriented multilayer film 100 having a first surface 104 and a second surface 106. A layer of vapor deposited material 150 (i.e., vapor deposited layer) is located on the first surface 104 of the unoriented multilayer film 100. The layers of the unoriented multilayer film 100 and the vapor deposited layer 100 will be discussed in more detail below. The recyclable packaging film 50 may also include a sealing layer to facilitate formation into a package. The sealing layer may be in any location on a surface of the recyclable packaging film and may be continuous or patterned, which will be discussed in further detail.

As used herein, the recyclability of the recyclable packaging film is defined as having a total composition including greater than 90%, greater than 92%, greater than 94%, greater than 96% or greater than 98% polyethylene-based polymers, by weight. Correspondingly, the recyclable packaging film includes less than 10%, less than 8%, less than 6%, less than 4% or less than 2% of non-polyethylene-based polymer materials (i.e., contaminates). Advantageously, the high level of polyethylene-based polymers and low level of contaminates facilitates easy recycling of the recyclable packaging film, and packages made thereof, in polyethylene recycling streams.

By using the design features of the recyclable packaging film as described herein, the inventors found that the recyclable packaging film had an unexpectedly and advantageously low moisture vapor transmission rate (MVTR). Moisture vapor transmission rate, also called water vapor transmission rate (WVTR), is the amount of water vapor that passes through a film or other article over a specific period of time. Package developers use various methods of moisture transmission control to ensure the integrity and shelf life of their products, including foods, pharmaceuticals, and other moisture sensitive products. The MVTR values reported herein have been measured according to packaging industry standards using conditions of 100° F. and 90% Rh, according to ASTM F1249. Some embodiments of the recyclable packaging film exhibit MVTR levels of less than 0.2 g/m²/day which is comparable to high barrier metalized biaxially oriented polypropylene (BOPP) films. The recyclable packaging films described herein may even be capable of delivering MVTR performance such that they can be used to replace foil containing packaging films.

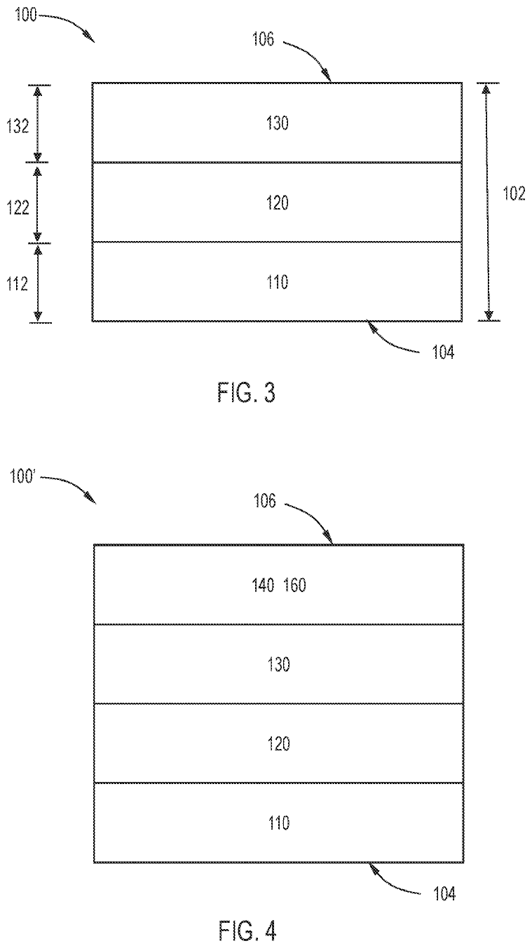

As noted, the recyclable packaging films include an unoriented multilayer film which will be generally described here with reference to FIG. 3. The embodiment of the unoriented multilayer film 100 includes a first layer 110 located at the first surface 104 and a third layer 130 located at the second surface 106. A second layer 120 is located between the first layer 110 and the third layer 130. As shown, the second layer 120 may be directly adjacent to the first layer 110 and the third layer 130 may be directly adjacent to the second layer 120.

The term “layer”, as used herein, refers to a building block of a film or laminate that is a structure of a single material type, a homogeneous blend of materials or a dispersion blend of materials. A layer may be a single polymer, a blend of materials within a single polymer type or a blend of various polymers, may contain metallic materials and may have additives. Layers may be continuous with the film (i.e., coextensive with the film) or layers may be discontinuous or patterned. A layer has an insignificant thickness (z direction) as compared to the length and width (x-y direction), and therefore is defined to have two major surfaces, the area of which are defined by the length and width of the layer. A layer may have sub-layers.

Similarly, the term “film”, as used herein, refers to a web built of layers and/or films, all of which are adjacent to and connected to each other. For example, a film may be two multilayer films, attached to each other by a layer of adhesive. A film can be described as having a thickness that is insignificant as compared to the length and width of the film. Films are generally regarded as having two major surfaces, opposite each other, expanding in the length and width directions. As used herein, a “laminate” is a film that may be built from an unlimited number of films and/or layers, the films and/or layers being bonded together by any known process such as, but not limited to, coextrusion, coating or laminating, to form a composite article. As used herein, layers or films that are “in direct contact with” or “are directly adjacent to” each other have no intervening material between them.

The recyclable packaging film includes an unoriented multilayer film. As used herein, the term “unoriented” refers to a monolayer or multilayer film, sheet or web that is substantially free of post-extrusion orientation. A film is unoriented if each of the layers or films that are part of the film is substantially free of post-extrusion orientation. As understood in the flexible packaging industry, orientation may be the result of monoaxially oriented (machine direction or transverse direction), or biaxially oriented (machine direction and transverse direction) stretching of the film, increasing the machine direction and/or transverse direction dimension and subsequently decreasing the thickness of the material. Orientation may be imparted into a film in either or both directions at a temperature just below the melt temperature of the polymers in the film. In this manner, the stretching causes the polymer chains to “orient”, changing the physical properties of the film. At the same time, the stretching thins the film. The resulting oriented films are thinner and can have significant changes in mechanical properties such as toughness, heat resistance, stiffness, tear strength and barrier. Orientation is typically accomplished by a double- or triple-bubble process, by a tenter-frame process or an MDO process using heated rolls. A typical blown film process or cast film process does impart some stretching of the film, but not enough to be considered oriented as described herein.

Referring to the embodiment of the unoriented multilayer film 100 shown in FIG. 3, we describe the first layer 110 in more detail. The first layer 110 is located at the first surface 104 of the unoriented multilayer film 100 and serves as the surface to which the vapor deposited layer is attached. The first layer 110 has a thickness 112 which is in a range of from 5% to 15% of the thickness 102 of the unoriented multilayer film 100. The first layer 110 may have a thickness 112 in the range of from 1 micron to 10 micron. The first layer 110 includes a polymer selected from the categories of cyclic olefin copolymer, ethylene vinyl alcohol copolymer and polyamide, as described below.

In some embodiments, the polymers included in the first layer are fully amorphous which is related to the crystallinity of the polymer. This amorphous character lends itself to an extremely smooth surface, which subsequently improves the quality of layer deposition and subsequent barrier. The degree of crystallinity of a polymer is directly related to whether the polymer melts like a typical solid or whether it transitions between glassy and rubbery states without a sharp phase change. Highly crystalline polymers have a more traditional melting point such that when they are heated, they reach a certain temperature at which the orderly arrangement of their long-chain structure transitions to a random and disorganized arrangement. This value is usually a specific number, designated as the melting point (Tₘ). Amorphous polymers don't melt suddenly when they're heated. Instead, when heated they reach a range of temperatures over which the material becomes less glassy and more rubber-like. As a result, amorphous polymers don't have a melting point—they have a glass transition temperature (T_{g}). The glass transition temperature of a specific polymer may be listed as a single temperature, but this number is a representative value representing a range of temperatures. Polymers may have crystalline regions and amorphous regions. However, fully amorphous polymers have very little or no crystalline regions and display no melting point characteristics when analyzed by DSC techniques. An amorphous polymer is a material generally recognized by one skilled in the art by differential scanning calorimetry (DSC) as having no measurable melting point (less than 0.5 calories/g) and no heat of fusion as measured by DSC using ASTM 3417-83.

The first layer may comprise a cyclic olefin copolymer (COC). The first layer may include at least 80%, at least 85%, at least 90%, at least 95% or 100% of one or more cyclic olefin copolymers, by weight. As used throughout this disclosure, the term “cyclic olefin copolymer” refers to polymers produced by the copolymerization of cyclic monomers with ethene. Examples of cyclic olefin copolymers include ethylene norbornene copolymers. The properties of cyclic olefin copolymers, such as T_{g} (glass transition temperatures), may vary widely based on monomer content. The cyclic olefin copolymer included in the first layer may have a glass transition temperature in a range of from 60° C. to 180° C. or from 60° C. to 140° C. The cyclic olefin copolymer may have a glass transition temperature below 180° C. or below 140° C.

The first layer may comprise an ethylene vinyl alcohol copolymer (EVOH). The first layer may include at least 80%, at least 85%, at least 90%, at least 95% or 100% of one or more ethylene vinyl alcohol copolymers, by weight. As used throughout this application, the term “ethylene vinyl alcohol copolymer”, “EVOH copolymer” or “EVOH” refers to copolymers comprised of repeating units of ethylene and vinyl alcohol. Ethylene vinyl alcohol copolymers may be represented by the general formula: [(CH₂—CH₂)ₙ—(CH₂—CH(OH))]ₙ. Ethylene vinyl alcohol copolymers may include saponified or hydrolyzed ethylene vinyl acetate copolymers. EVOH refers to a vinyl alcohol copolymer having an ethylene co-monomer and prepared by, for example, hydrolysis of vinyl acetate copolymers or by chemical reactions with vinyl alcohol. Ethylene vinyl alcohol copolymers may comprise from 27 mole percent (or less) to 48 mole percent (or greater) ethylene.

The first layer may comprise a polyamide (PA). The first layer may include at least 80%, at least 85%, at least 90%, at least 95% or 100% of one or more polyamides, by weight. The term “polyamide” or “PA” refers to a high molecular weight polymer having amide linkages (—CONH—)ₙ which occur along the molecular chain, and includes “nylon” resins which are well known polymers having a multitude of uses including utility in packaging films. Examples of nylon polymeric resins include: nylon 66, nylon 610, nylon 66/610, nylon 6/66, nylon 11, nylon 6, nylon 66T, nylon 612, nylon 12, nylon 6/12, nylon 6/69, nylon 46, nylon 6-3-T, nylon MXD-6, nylon MXDI, nylon 12T and nylon 6I/6T.

The first layer may be free from polyethylene polymers.

The first layer may be free from inorganic particulates such as antiblock agents and slip agents, as these can disrupt the smoothness of the first surface, causing defects in the vapor deposited layer. As defined herein, “particulates” are small particles having maximum dimension (i.e., the largest cross-dimension in any direction) of approximately 0.1 micron to 3 micron.

Referring to the embodiment of the unoriented multilayer film 100 shown in FIG. 3, we describe the second layer 120 in more detail. The second layer 120 is located between the first layer 110 and the third layer 130. In some embodiments, such as shown in FIG. 3, the second layer 120 is directly adjacent to the first layer 110. In some embodiments, such as shown in FIG. 3, the second layer 120 is directly adjacent to the third layer 130. The second layer 120 has a thickness 122 which is in a range of from 5% to 60%, or from 5% to 30%, of the thickness 102 of the unoriented multilayer film 100. The second layer 120 may have a thickness 112 in the range of from 10 micron to 50 micron. The second layer 120 includes a polyethylene polymer having a density in a range of from 0.89 g/cm³ to 0.94 g/cm³ or in a range of from 0.910 g/cm³ to 0.940 g/cm³.

As used throughout this application, the term “polyethylene polymer”, “polyethylene” or “PE” refers to, unless indicated otherwise, ethylene homopolymers or copolymers. The term “polyethylene” or “PE” is used without regard to the presence or absence of substituent branch groups. Polyethylene includes, for example, medium density polyethylene, high density polyethylene, low density polyethylene, linear low-density polyethylene, ultra-low density polyethylene, ethylene alpha-olefin copolymer, or blends of such. The second layer may contain at least 80%, at least 90% or 100% polyethylene polymer having a density in a range of from 0.89 g/cm³ to 0.94 g/cm³ or in a range of from 0.910 g/cm³ to 0.940 g/cm³, by weight.

As used throughout this application the term “medium-density polyethylene” of “MDPE” refers to homopolymers and copolymers of ethylene having a density from about 0.926 g/cm³ to about 0.940 g/cm³. Some embodiments of the unoriented multilayer film include a second layer including MDPE. Some embodiments of the unoriented multilayer film include a second layer including at least 60%, at least 70%, at least 80%, at least 90% or 100% MDPE, by weight. In some embodiments of the unoriented multilayer film the second layer includes at least 65% MDPE and at least 35% of another polyethylene polymer, by weight.

Referring to the embodiment of the unoriented multilayer film 100 shown in FIG. 3, we describe the third layer 130 in more detail. The third layer 130 is located at the second surface 106 of the unoriented multilayer film 100. The third layer 130 has a thickness 132 which is in a range of from 15% to 75%, or from 50 to 75%, of the thickness 102 of the unoriented multilayer film 100. The third layer 130 may have a thickness 132 in the range of from 1 micron to 50 micron. The third layer 130 includes a high-density polyethylene. The third layer may contain at least 80%, at least 90% or 100% polyethylene polymer. Some embodiments of the unoriented multilayer film include a third layer including at least 60%, at least 70%, at least 80%, at least 90% or 100% HDPE, by weight.

Examples of layer thickness ratios of unoriented multilayer films that include a first layer, a second layer and a third layer, as described above, include 10%/15%/75%, 15%/10%/75%, or 5%/50%/45%, where the layers are 1^{st}/2^{nd}/3^{rd}.

As used throughout this application, the term “high-density polyethylene” or “HDPE” refers to both (a) homopolymers of ethylene which have densities from about 0.960 g/cm³ to about 0.970 g/cm³ and (b) copolymers of ethylene and an alpha-olefin (usually 1-butene or 1-hexene) which have densities from about 0.940 g/cm³ to about 0.960 g/cm³. High-density polyethylene includes polymers made with Ziegler or Phillips type catalysts and polymers made with single site metallocene catalysts. The third layer includes at least 90% high-density polyethylene, by weight. In some embodiments, the third layer contains 100% high-density polyethylene. The high-density polyethylene may be bimodal regarding molecular weight. Bimodal high-density polyethylene (HDPE) resins benefit from their bimodality by having the strength and stiffness of HDPE while retaining other properties of a unimodal medium density polyethylene. The high-density polyethylene may have a melt flow rate (i.e., melt index) greater than 1 g/10 min, as measured by ASTM D1238-10 “Standard Test Method for Melt Flow Rates of Thermoplastics by Extrusion Plastometer” at conditions of 190° C./2.16 kg. The third layer may include a high-density polyethylene that has been nucleated.

Choosing a high-density polyethylene for the third layer having bimodality, having a melt flow rate greater than 1 g/10 min and including a nucleating agent may allow for faster crystallization and thus greater stiffness of the third layer. Without being bound by theory, the inventors believe that the stiffness of the third layer, in conjunction with being spaced from the first layer, lead to improved barrier of the recyclable packaging film. The increased stiffness of the third layer prevents curling, and as a result of the structure and components of the unoriented multilayer film, the recyclable packaging film may have a curl of less than 90% or less than 80% or less than 70% or less than 60% or less than 50%, according to the X-Cut Curl Test defined below.

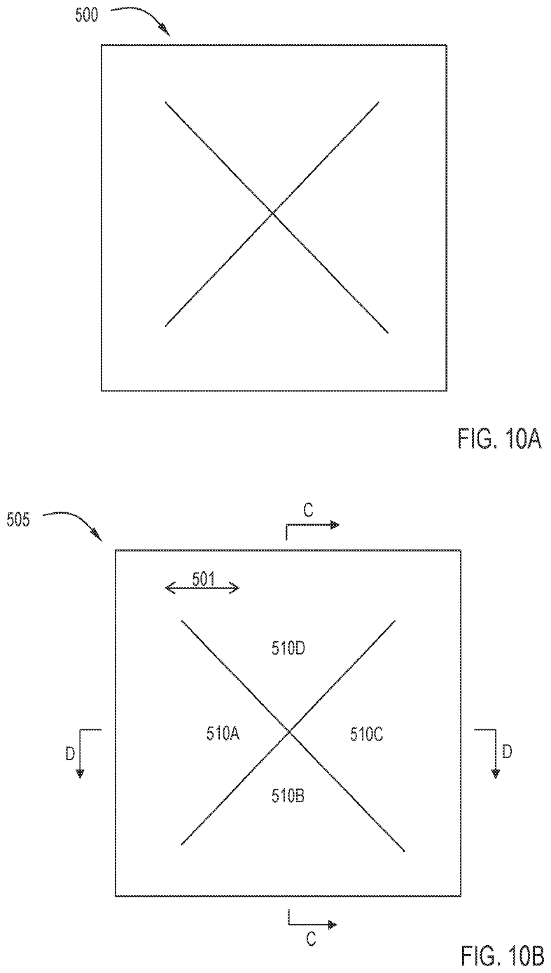

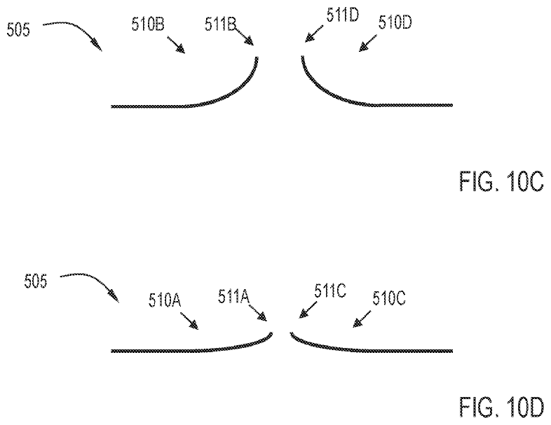

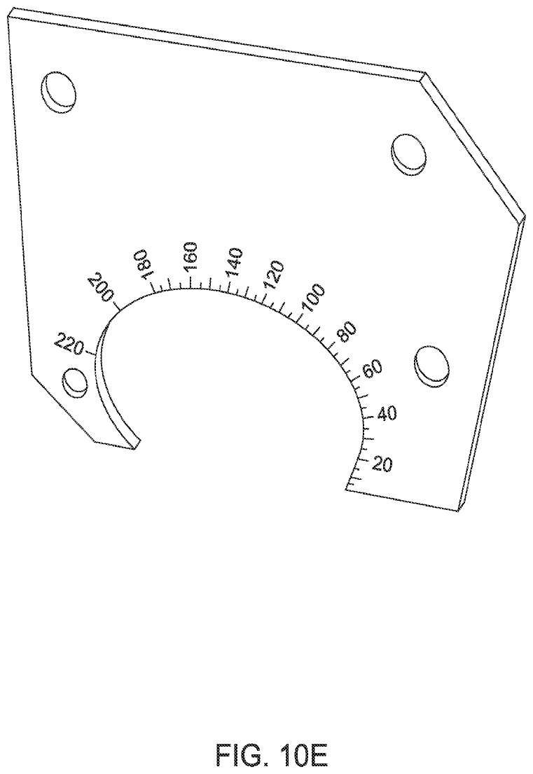

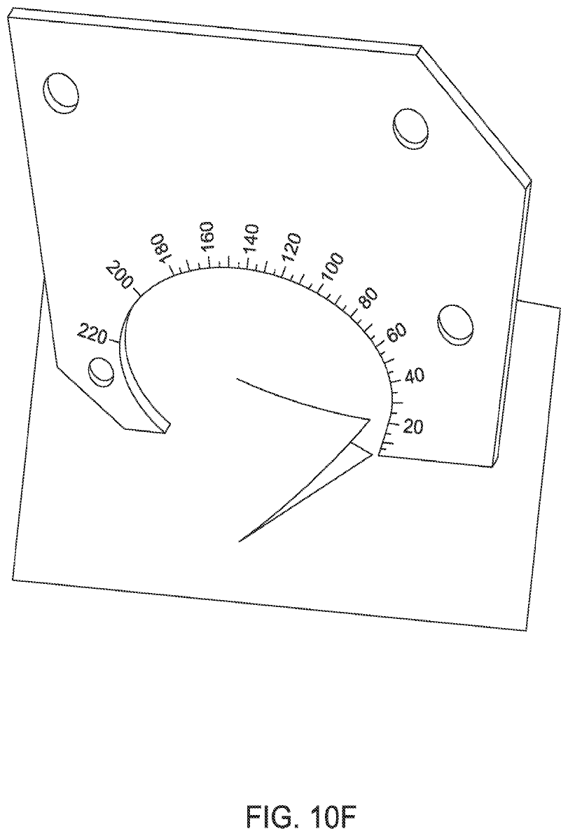

The curl of a film as denoted herein is measured by an “X-Cut” curl test. A film sample is obtained, and the machine direction is noted. The film sample should be kept at 73° F. and 50% relative humidity during the measurement, as well as at least 24 hours prior to the measurement. The film sample must be large enough to accommodate a complete “X” cut, as will be described. A cutting template 500 according to the design shown in FIG. 10A is laid on top of a film sample and an X is cut into the film sample, following the template. The template 500 has an X shape to guide cutting, the X formed by two overlapping lines, each having a length of four inches. The resulting film sample 505, as shown in FIG. 10B, has four triangle segments (510A, 510B, 510C, 510D). The length of each cut edge of each triangle segment is two inches. The triangle segments 510A and 510C point in the machine direction 501 of the film sample 505, and the triangle segments 510B and 510D point in the transverse direction of the film sample 505. Each triangle segment has a corresponding free point (511A, 511B, 511C, 511D) as are shown as the side views of the film sample 505 in FIGS. 10C and 10D. FIGS. 10C and 10D show the curl of the film sample after the X has been cut and the template removed from the film sample 505. If the free points do not curl up, away from the worktable, turn the film sample over so that they do.

To measure the curl in the machine direction (MD), use an angle template from Reynolds & Co. Inc. Curl Tester D-3285 (as shown in FIG. 10E). Place the angle template with the 0 degree edge of the scale approximately 1 mm from the tip of the free point to be measured (See FIG. 10F). The curl of the film is where the free point is closest to the angle template.

Now shifting to the embodiment of the unoriented multilayer film 100′ shown in FIG. 4, we describe a fourth layer 140 that may be present. The embodiment shown has a fourth layer 140 that is specifically a sealing layer 160. In this case, the sealing layer 140,160 is located at the second surface 106 of the unoriented multilayer film 100′ and directly adjacent to the third layer 130. The sealing layer 160 is coextensive with the unoriented multilayer film 100′. The fourth layer 140 may comprise at least 80%, at least 90% or 100% polyethylene polymer, by weight.

Examples of layer thickness ratios of unoriented multilayer films that include a first layer, a second layer, third layer and fourth layer, as described above, include 5%/10%/75%/10%, 15%/10%/65%/10%, 10%/60%/10%/20% or 5%/55%/5%/35%, where the layers are 1^{st}/2^{nd}/3^{rd}/4^{th}.

As used herein, the term “sealing layer” is a layer of the recyclable packaging film that is located at an exterior surface, providing for adhesion by sealing to a surface of another article. The sealing layer may contain materials, such as low seal temperature polymers, that are suitable to form heat seals. The sealing layer may contain materials that form seals under pressure alone, i.e., cold seal blends.

The sealing layer of the recyclable packaging film may have a composition that will allow the formation of a heat seal, thus forming a hermetically sealed package. As used herein, the term “heat seal”, “heat sealable” or “heat sealed” refers to two or more surfaces that have been or can be bonded together by application of both heat and pressure. Heat sealing is a well-known and commonly used process for creating packages and is familiar to those skilled in the art. Without intending to be bound by theory, during heat sealing, the sealing layer softens due to the application of heat, allowing formation of a heat seal bond. Since the heat must be driven through the entire recyclable packaging film to raise the temperature of the sealing layer, it is advantageous if the heat sealable material softens and seals at a relatively low temperature. Lower seal initiation temperature (SIT) enables faster packaging line speeds. For example, some embodiments of the recyclable packaging film may include a sealing layer that exhibits an SIT of less than or equal to 140° C., less than or equal to 130° C., or less than or equal to 120° C. Possible heat sealable materials included in a sealing layer may include, but are not limited to, acrylate copolymers, PET, PE, PP, or hot melts (wax based).

The sealing layer may alternatively be a pressure sensitive cold seal. This embodiment of the recyclable packaging film is advantageous as formation of the package does not require heat. Without intending to be bound by theory, the pressure sensitive cold seal may be advantageous for the packaging of heat sensitive products such as ice cream or chocolates. Embodiments of the recyclable packaging film may include a pressure sensitive cold seal system including, but not limited to, natural or synthetic polyisoprene latex, or styrene-butadiene copolymer latex. The cold seal material may comprise blends that include acrylates and/or tackifiers.

In other embodiments of the unoriented multilayer film, the fourth layer may be located at the second surface of the unoriented multilayer film but is a lamination layer instead of a sealing layer. A lamination layer may be formulated to provide for good adhesion to another surface within a laminate. In other words, a lamination layer is an outer layer of a film, such as the unoriented multilayer film, that becomes adjacent to an adhesive layer within a lamination, such as the recyclable packaging film.

The unoriented multilayer film may contain additional layers in any position.

The vapor deposited layer is located on the first surface of the unoriented multilayer film. The vapor deposited layer may include one or more metals, such as aluminum. The vapor deposited layer may include inorganic oxides, such as aluminum oxide or silicon oxide. The vapor deposited layer may have a thickness in a range of from 0.005 and 0.1 micron. The vapor deposited layer has been applied to the first surface of the unoriented film by way of any one of a variety of known vapor deposition methods, resulting in a very thin, high moisture barrier layer. Vapor deposition methods may include, but are not limited to, vacuum deposition, chemical vapor deposition, sputtering and electroplating. Vapor deposition methods involve some act or method of depositing a continuous metal, metal oxide or metal alloy layer onto the surface of a polymer substrate.

The metal used can vary, though aluminum, silicon, zinc, gold, silver, or appropriate alloys of such are preferred, with aluminum or aluminum-containing alloys being particularly preferred. As will be recognized by those skilled in the art, while the metal coating predominantly consists of the identified metal (such as aluminum), amounts of other additives may be present to improve assorted physical and optical properties of the deposited metal layer. On some occasions, pure aluminum (or the metal of choice) may be used. Other additives maybe used in minor amounts such that aluminum (or the metal of choice) is the major component. Vacuum deposition is a preferred method of metallization in tends of processing and cost. Regardless, the metal coating preferably has a thickness less than the polymer substrate on which it is deposited, preferably substantially less than said substrate. In contrast, typical metal foils used in packaging film application have a thickness of between 4.3 to 150 microns.

The vapor deposited layer may be an aluminum layer, as is commonly used in films intended for packaging. Thin aluminum layers are typically applied to oriented films such as oriented polyester (OPET) or oriented polypropylene (OPP). The aluminum may be applied to the unoriented multilayer film in a thickness sufficient to achieve an optical density in a range of from 1.0 to 4.5, or from 1.5 to 4.5 or from 1.5 to 3.0 The optical density of a film may be measured by ASTM D1003.

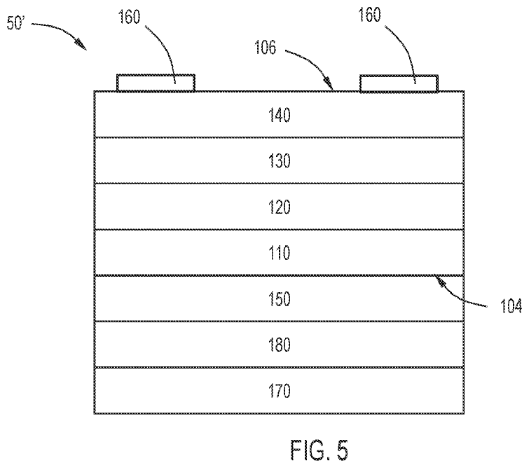

As discussed previously, the unoriented multilayer film may include a sealing layer located at the second surface (see FIG. 4). Alternatively, the recyclable packaging film may incorporate a sealing layer that is not within the unoriented multilayer film. In these embodiments, a sealing layer is attached to the unoriented multilayer film and may be located on either side of the unoriented multilayer film. In any embodiment, the sealing layer may be located at a surface of the recyclable packaging film such that it can perform sealing functionality. Examples of sealing layers that are not within the unoriented multilayer film are shown in FIGS. 5, 6 and 8.

In some embodiments, the sealing layer acts as a caulking agent. In some embodiments, the sealing layer flows into a gap of a triple point region (described below) at the sealing conditions. Without intending to be bound by theory, the ability to properly seal the triple-point may result from a combination of material properties, coating weight and sealing conditions. It is believed that having a sealing material that is relatively thick in the areas of the heat seals greatly increases the potential to reduce the size of the triple point region of the seal. In one or more preferred embodiments, the sealing layer is not oriented.

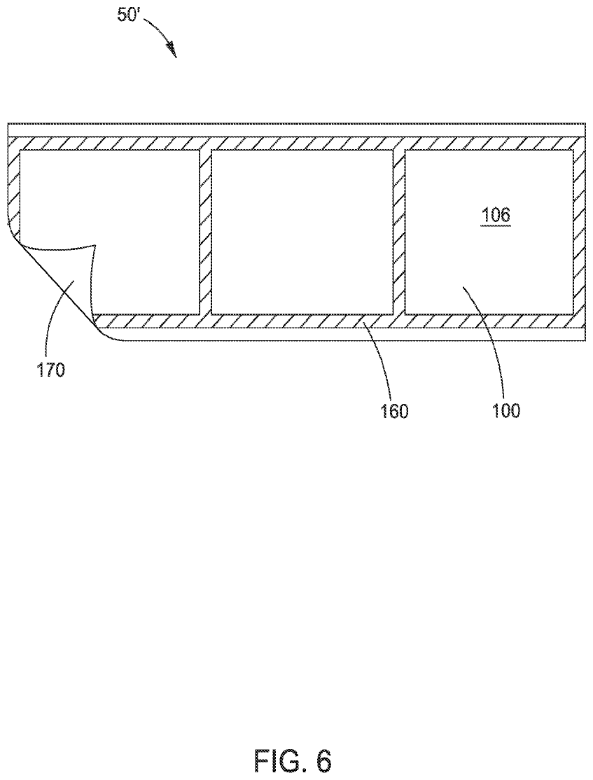

An embodiment of a recyclable packaging film 50′ having a patterned sealing layer 160 is shown in FIG. 5 (a cross-sectional view) and FIG. 6 (a plan view). Recyclable packaging film 50′ includes an unoriented multilayer film having a first layer 110, a second layer 120, a third layer 130, a fourth layer 140, a first surface 104 and a second surface 106. The patterned sealing layer 160 is attached to the second surface 106 of the unoriented multilayer film (pattern of application shown in hash marked area in FIG. 6). As discussed previously, the unoriented multilayer film has a vapor deposited layer 150 located on the first surface 104. Additionally, the recyclable packaging film 50′ includes an oriented polyethylene film 170 attached to the vapor deposited layer 150 by an adhesive layer 180.

The pattern of the sealing layer, an example shown in FIG. 6, may be located specifically in the areas required for sealing. Such location of the patterned sealing layer permits hermetic, allowing for minimization of material while retaining high performance. As used herein, the term “patterned” means that the sealing layer is discontinuous with the recyclable packaging film. The sealing layer is discontinuous with the polymeric film upon which it is applied. The sealing layer may be applied to areas of the recyclable packaging film that are involved with closing the package by sealing. The sealing layer may be applied over greater than or equal to 5%, greater than or equal to 10%, or greater than or equal to 15% of the surface of the polymeric film. The sealable material may be applied over less than or equal to 30%, less than or equal to 25%, or less than or equal to 20% of the polymeric film. As a result, the interior surface of the recyclable packaging film is partially the unoriented multilayer film and partially the sealing layer. For example, the interior surface of the recyclable packaging film may be approximately 80% polymeric film and 20% sealing layer. The interior surface may consist essentially of or consist of the polymeric film and the sealing layer.

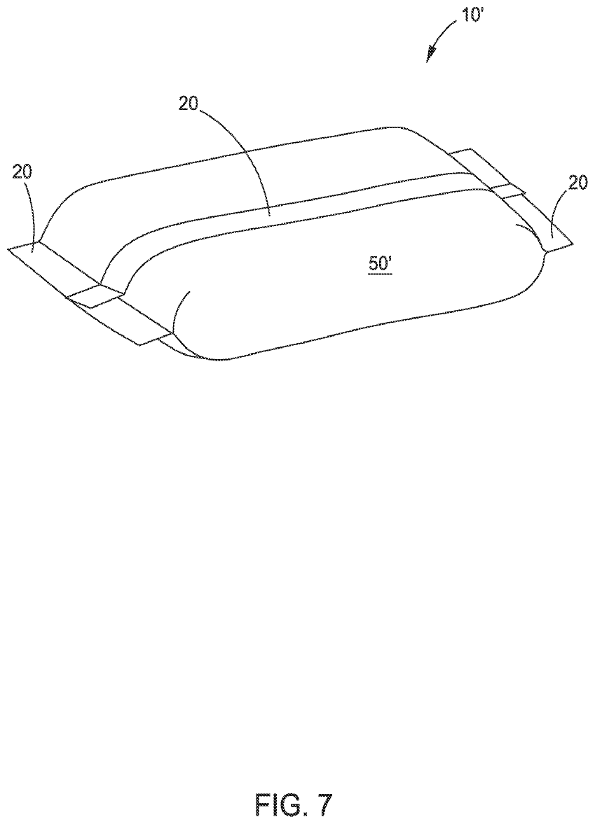

FIG. 6 shows the plan view of the interior surface of an embodiment of a recyclable packaging film 50′ which may be useful for producing a flow-wrap style package, such as package 10′ shown in FIG. 7. The package 10′ of FIG. 7 is made entirely of the recyclable packaging film 50′, sealed to itself at seals 20 along the length and ends of the package. The interior surface of the package also includes the second surface 106 of the unoriented multilayer film in the regions not covered by the sealable layer 160. In FIG. 6, the bottom corner of the recyclable packaging film 50′ is turned up to expose the oriented polyethylene film 170 on the opposite surface.

The sealing layer may be applied at a thickness that allows for hermetic sealing, even in challenging applications such as triple point region sealing. In some embodiments, the sealing layer may be applied at a basis weight of greater than or equal to 1 g/m² or greater than or equal to 3 g/m². In other embodiments, the sealing layer may be applied at a basis weight of less than or equal to 8 g/m², less than or equal to 9 g/m², or less than or equal to 10 g/m². For example, the sealing layer may have a basis weight in a range of from about 1 g/m² to about 10 g/m², or in a range of from about 3 g/m² to about 9 g/m².

As used herein, the term “basis weight” is used to refer to the amount of material by weight is present in a predetermined area of a film or layer. Typically, the area defined is a square meter, but any area can be used. The area is defined in the length-width (i.e., x-y direction) of the film or layer. A material of a given thickness (z-direction) and density, has a specific weight when covering a defined area (i.e., a square meter). Materials that are applied in discontinuous layers, such as the patterned sealing layers, can be defined by basis weight. In the case of patterns, the basis weight refers to the amount of material by weight that is present when covering a defined area. The use of basis weight to measure weight of materials such as patterned materials is common in the film converting industry.

The term “adhesive layer,” or “tie layer,” refers to a layer or material placed on one or more layers to promote the adhesion of that layer to another surface. For example, tie layers may be positioned between two layers of a multilayer film to maintain the two layers in position relative to each other and prevent undesirable delamination. In another example, adhesive layers may be positioned between two films of a laminate to maintain the two layers in position relative to each other and prevent undesirable delamination. An adhesive layer may be formed by a traditional 2-component reactive system, which may be solvent based, solvent free, water-based or energy cured. An adhesive layer may be a polymeric layer applied by an extrusion lamination process.

The oriented polyethylene film included in the recyclable packaging film shown in FIGS. 5 and 6 may be machine direction oriented (MDOPE) or biaxially oriented (BOPE). The oriented polyethylene film may be monolayer or multilayer. The oriented polyethylene film may contain at least 80%, at least 90% or 100% polyethylene polymers, by weight. The oriented polyethylene film may be a machine direction oriented (MDO) film and may include HDPE.

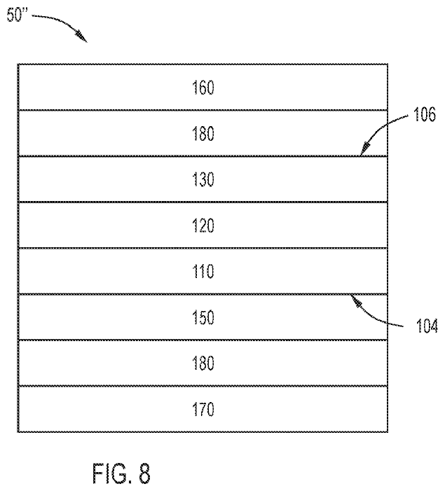

Another embodiment of the recyclable packaging film 50″ is shown in FIG. 8. The recyclable packaging film 50″ includes an unoriented multilayer film having a first layer 110, as second layer 120, a third layer 130, a first surface 104 and a second surface 106. The vapor deposited layer is located on the first surface 104 of the unoriented multilayer film. As previously described in FIG. 5, this embodiment includes an oriented polyethylene film 170 connected to the vapor deposited layer 150 by an adhesive layer 180. A second adhesive layer 180 adheres a sealing layer 160, in the form of a sealing film, to the second surface 106 of the unoriented multilayer film.

In other embodiments of the recyclable packaging film, a sealing layer may be applied to the structure without the use of an adhesive layer, by way of an extrusion coating process, for example.

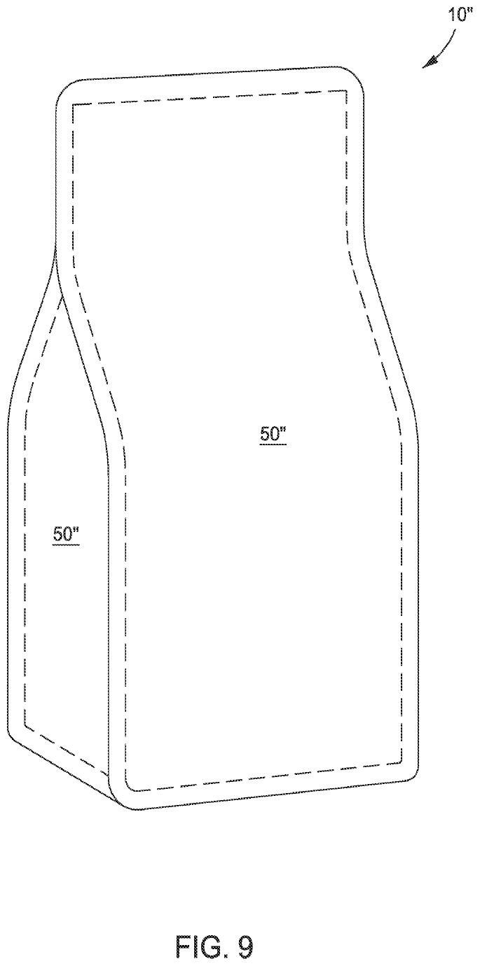

The recyclable packaging film 50″ of FIG. 8 may be suitable for use in a package 10″ such as that shown in FIG. 9. The package 10″ shown is a side and bottom gusseted pouch. Each panel of the package 10″ is constructed from the recyclable packaging film 50″.

The overall design of the recyclable packaging film as disclosed herein provides for an advantageous combination of film characteristics that had been previously unachievable. The design of the film incorporates a relatively thin film having extremely good barrier properties, while retaining recyclability in the polyethylene flexibles stream due to high polyethylene content. Specifically, the design of the unoriented multilayer film results in a low curl/high stiffness film which demonstrates enhanced barrier properties upon metallization. Additionally, the unoriented format of the film adds to the puncture resistance of the film. Of further advantage is the unoriented nature of the film, which allows for a high-performance sealing layer to be incorporated easily within a fully coextruded film.

As previously discussed, the recyclable packaging films may be used in packages. The recyclable packaging film may be sealed to itself or to other packaging components. The packages may be in various formats and may be advantageously hermetically sealed. Hermetic sealing provides protection to the packaged product (i.e., the product sealed within the package). Packages may take the form of those discussed in detail here (tray/lid of FIG. 1, flowwrap of FIG. 7, pouch of FIG. 9) or any other format such as a sachet. The seals used to form the package may be fusion or peelable, as is commonly known by those skilled in packaging. The packages may have opening features such as peelable seals, tear notches or laser scoring.

Packaging components used in addition to the recyclable packaging film may include, but is not limited to, cups, trays, paper/paperboard, zippers or spouts. The packaging components, including the recyclable packaging film, may be each independently recyclable. Some packaging components may not be recyclable but are then separable from the recyclable packaging components. Each of the packaging components may be recyclable within the same recycling stream and therefore may stay connected upon opening of the package. The package may have a total composition including greater than 90%, greater than 92%, greater than 94%, greater than 96% or greater than 98% polyethylene-based polymers, by weight. Correspondingly, the total composition of the package may include less than 10%, less than 8%, less than 6%, less than 4% or less than 2% of non-polyethylene-based polymer materials (i.e., contaminates).

### EXAMPLES

### Example 1: Easy Tear Functionality

An unoriented multilayer film was produced by a blown film process. The overall thickness of the film was 1.25 mil (31.75 micron) and the basis weight is about 19.0 lb/rm. The layer details are summarized in Table 1. The layer contents listed were melt blended to produce a consistently homogenous layer. In the listing of the layer contents, the values are given in % by weight. The first layer of the unoriented multilayer film was free from antiblock, slip and polyethylene polymer.

The unoriented multilayer film was then metalized with aluminum using a vacuum deposition method. The aluminum metalization was applied to the exposed surface of the first layer. The final optical density of the film was 3.8. The resulting MVTR of this metalized unoriented film was 0.107 g/m²/day, measured at 100° F. and 90% Rh, according to ASTM F1249.

The metalized unoriented multilayer film was then adhesive laminated to a 1 mil (25.4 micron) MDOPE film having a general structure of HDPE/mLLDPE/HDPE/mLLDPE/HDPE. The MDOPE film had been oriented in the machine direction at a ratio of 5.5 to 1. The MDOPE was attached to the metalized surface of the metalized unoriented multilayer film. About 1.25 lb/rm adhesive was used in the lamination.

Finally, a patterned cold seal layer was applied to the exposed fourth layer of the unoriented multilayer film. The cold seal material was applied at about 43.5 lb/rm.

Thusly, the final recyclable packaging film of Example 1 had a structure of: 1 mil MDOPE/adhesive/vapor deposited layer/1.25 mil unoriented multilayer film/cold seal. This film had a total composition including 92% polyethylene-based materials, by weight.

TABLE 1
Structure Details of the Unoriented Multilayer Film of Example 1

| | Thickness as a | |
|---|---|---|
| | % of Overall | |
| Layer | Film Thickness | Layer Contents |
| First Layer | 8% | 100% COC having Tg of 78° C. |
| Second Layer | 15% | 70% 0.935 g/cm³, 0.5 MI MDPE |
| | | 30% 0.895 g/cm³, 1.6 MI plastomer |
| Third Layer | 67% | 99% 0.967 g/cm³, 1.2 MI, bimodal |
| | | HDPE, 1% nucleating agent |
| | | masterbatch |
| Fourth Layer | 10% | 97% 0.935 g/cm³, 0.5 MI MDPE plus |
| | | antiblock and process aide masterbatch |

The recyclable packaging film of Example 1 had an MVTR of about 0.06 g/m2/day measured at 100° F. and 90% Rh, according to ASTM F1249 and an OTR of about 1.75 cm3/m2/day, measured at 73° F. and 0% Rh, according to ASTM F1927. The mechanical testing results conducted on Example 1 are shown in Table 2.

TABLE 2
Mechanical Testing Results for the Recyclable
Packaging Film of Example 1

| | Test Procedure/ | | |
|---|---|---|---|
| Property Measured | Conditions | Results | |
| Elmendorf Tear, notched, | ASTM D1922, 200 | 90.6 g (average of | |
| MD | g | 10 measurements) | |
| Elmendorf Tear, un- | ASTM D1922, 6400 | 89 g (average of | |
| notched, MD | g | 10 measurements) | |
| Elmendorf Tear, notched, | ASTM D1922, 400 | 226.2 g (average of | |
| TD | g | 10 measurements) | |
| Elmendorf Tear, un- | ASTM D1922, 6400 | 256 g (average of | |
| notched, TD | g | 10 measurements) | |
| Trouser Tear, MD peak | ASTM D1938 | 575 g (average of 5 | |
| | | measurements) | |
| Trouser Tear, MD | ASTM D1938 | 344 g (average of 5 | |
| average | | measurements) | |
| Trouser Tear, TD peak | ASTM D1938 | 975 g (average of 5 | |
| | | measurements) | |
| Trouser Tear, TD average | ASTM D1938 | 697 g (average of 5 | |
| | | measurements) | |
| “X-Cut” Curl Test | Described herein | 56 degrees MD, | |
| | | 21 degrees TD | |
| Tensile, Force at Break, | ASTM D882, 4 inch | 26.98 | lb |
| MD | span, 2 in/min | | |
| | crosshead speed | | |
| Tensile, Stress at Break, | ASTM D882, 4 inch | 10,979 | psi |
| MD | span, 2 in/min | | |
| | crosshead speed | | |
| Tensile, Elongation at | ASTM D882, 4 inch | 84.81% | |
| Break, MD | span, 2 in/min | | |
| | crosshead speed | | |
| Tensile, Energy | ASTM D882, 4 inch | 20.06 | lb/in |
| Absorption, MD | span, 2 in/min | | |
| | crosshead speed | | |
| Tensile, Stress at Yield, | ASTM D882, 4 inch | 10,950 | psi |
| MD | span, 2 in/min | | |
| | crosshead speed | | |
| Tensile, Force at Break, | ASTM D882, 5 inch | 9.93 | lb |
| TD | span, 0.5 in/min | | |
| | crosshead speed | | |
| Tensile, Stress at Break, | ASTM D882, 5 inch | 4,194 | psi |
| TD | span, 0.5 in/min | | |
| | crosshead speed | | |
| Tensile, Elongation at | ASTM D882, 5 inch | 3.64% | |
| Break, TD | span, 0.5 in/min | | |
| | crosshead speed | | |
| Tensile, Energy | ASTM D882, 5 inch | 0.25 | lb/in |
| Absorption, TD | span, 0.5 in/min | | |
| | crosshead speed | | |
| Tensile, Stress at Yield, | ASTM D882, 5 inch | 4,204 | psi |
| TD | span, 0.5 in/min | | |
| | crosshead speed | | |

### Example 2: Drop Resistance Functionality

An unoriented multilayer film was produced by a blown film process. The overall thickness of the film was 1.25 mil (31.75 micron) and the basis weight is about 19.0 lb/rm. The layer details are summarized in Table 2. The layer contents listed were melt blended to produce a consistently homogenous layer. In the listing of the layer contents, the values are given in % by weight. The first layer of the unoriented multilayer film was free from antiblock, slip and polyethylene polymer.

The unoriented multilayer film was then metalized with aluminum using a vacuum deposition method. The aluminum metallization was applied to the exposed surface of the first layer. The final optical density of the film was 3.4. The resulting MVTR of this metalized unoriented film was 0.156 g/m²/day, measured at 100° F. and 90% Rh, according to ASTM F1249.

The metalized unoriented multilayer film was then extrusion laminated to a 1 mil (25.4 micron) MDOPE film having a general structure of HDPE/HDPE-mLLDPE/LMDPE/HDPE-mLLDPE/HDPE. The MDOPE film had been oriented in the machine direction at a ratio of 5.0 to 1. The MDOPE was attached to the metalized surface of the metalized unoriented multilayer film. About 7 lb/rm LDPE was used to adhere the films to create an intermediate lamination film.

The intermediate lamination film was then extrusion laminated to a 3 mil LLDPE blown film. The unoriented multilayer film side of the intermediate lamination film was attached to the LLDPE blown film. About 10 lb/rm LDPE was used to adhere the films to create the recyclable packaging film of Example 2, having the structure of: 1 mil MDOPE/7 lb/rm LDPE/vapor deposited layer/1.25 mil unoriented multilayer film/10 lb/rm LDPE/3.0 mil LLDPE. This film has a total composition including nearly 100% polyethylene-based polymers.

TABLE 3
Structure Details of the Unoriented Multilayer Film of Example 2

| | Thickness as a | |
|---|---|---|
| | % of Overall | |
| Layer | Film Thickness | Layer Contents |
| First Layer | 8% | 100% COC having Tg of 78° C. |
| Second Layer | 51% | 100% 0.917 g/cm³, 0.9 MI LLDPE |
| Third Layer | 31% | 99% 0.967 g/cm³, 1.2 MI, bimodal |
| | | HDPE, 1% nucleating agent |
| | | masterbatch |
| Fourth Layer | 10% | 97% 0.935 g/cm³, 0.5 MI MDPE plus |
| | | antiblock and process aide masterbatch |

The recyclable packaging film of Example 2 had an MVTR of about 0.11 g/m²/day measured at 100° F. and 90% Rh, according to ASTM F1249 and an OTR of about 19 cm³/m²/day, measured at 73° F. and 0% Rh, according to ASTM F1927. The mechanical testing results conducted on Example 2 are shown in Table 4.

TABLE 4
Mechanical Testing Results for the Recyclable
Packaging Film of Example 2

| | Test Procedure/ | |
|---|---|---|
| Property Measured | Conditions | Results |
| Dart Drop, Peak Load | ASTM D7192, 0.25 | 21.1 lb (average of 5 |
| | in probe to sealant | measurements) |
| | side, 73° F. | |
| Dart Drop, Total | ASTM D7192, 0.25 | 0.62 inches (average |
| Deformation | in probe to sealant | of 5 measurements) |
| | side, 73° F. | |
| Dart Drop, Total | ASTM D7192, 0.25 | 0.59 ft-lb (average of |
| Energy | in probe to sealant | 5 measurements) |
| | side, 73° F. | |
| Puncture, Force | ASTM F1306, ASTM | 27.31 (average of 5 |
| | ⅛″ probe to sealant | measurements) |
| | side, 73° F. | |
| Puncture, | ASTM F1306, ASTM | 0.33 inches (average |
| Displacement | ⅛″ probe to sealant | of 5 measurements) |
| | side, 73° F. | |
| Elmendorf Tear, | ASTM D1922, 3200 g | 961 g (average of 10 |
| notched, MD | | measurements) |
| Elmendorf Tear, | ASTM D1922, 3200 g | 1607 g (average of 10 |
| notched, TD | | measurements) |
| “X-Cut” Curl Test, | Described herein | 60 degrees (average of |
| MD | | 5 measurements) |
| “X-Cut” Curl Test, | Described herein | 0 degrees (average of 5 |
| MD | | measurements) |
| Tensile, Force at | ASTM D882, 2 inch | 34.63 lb (average of 3 |
| Break, MD | span, 20 in/min | measurements) |
| | crosshead speed | |
| Tensile, Stress at | ASTM D882, 2 inch | 5,013 psi (average of 3 |
| Break, MD | span, 20 in/min | measurements) |
| | crosshead speed | |
| Tensile, Elongation at | ASTM D882, 2 inch | 96.7% (average of 3 |
| Break, MD | span, 20 in/min | measurements) |
| | crosshead speed | |
| Tensile, Energy | ASTM D882, 2 inch | 27.7 lb/in (average of |
| Absorption, MD | span, 20 in/min | 3 measurements) |
| | crosshead speed | |
| Tensile, Stress at | ASTM D882, 2 inch | No tensile at yield |
| Yield, MD | span, 20 in/min | |
| | crosshead speed | |
| Tensile, Force at | ASTM D882, 2 inch | 21.6 lb (average of 3 |
| Break, TD | span, 20 in/min | measurements) |
| | crosshead speed | |
| Tensile, Stress at | ASTM D882, 2 inch | 3,115 psi (average of 3 |
| Break, TD | span, 20 in/min | measurements) |
| | crosshead speed | |
| Tensile, Elongation at | ASTM D882, 2 inch | 967.3% (average of 3 |
| Break, TD | span, 20 in/min | measurements) |
| | crosshead speed | |
| Tensile, Energy | ASTM D882, 2 inch | 134.2 lb/in (average of |
| Absorption, TD | span, 20 in/min | 3 measurements) |
| | crosshead speed | |
| Tensile, Stress at | ASTM D882, 2 inch | 2,223 psi (average of 3 |
| Yield, TD | span, 20 in/min | measurements) |
| | crosshead speed | |
| Young's Modulus, | ASTM D882 | 68,336 psi (average of 3 |
| MD | | measurements) |
| Young's Modulus, | ASTM D882 | 82,464 psi (average of 3 |
| TD | | measurements) |
| 1% Secant, MD | ASTM D882 | 62,775 psi (average of 3 |
| | | measurements) |
| 1% Secant, TD | ASTM D882 | 74,051 psi (average of 3 |
| | | measurements) |

### Comparative Examples 3 and 4: Comparison of Metalized Films

As stated above, the metalized unoriented multilayered films used in Examples 1 and 2 (the unlaminated film), had excellent MVTR. These results are restated in Table 6 below, along with MVTR results for Comparative Example films 3 and 4.

Comparative Example 3 is a metalized 1.25 mil blown film having a general structure of LLDPE/tie/EVOH/tie/LLDPE/COC/vapor deposition. The detailed composition of the blown film is shown in Table 5. Of specific note, this film has a COC layer that contains polyethylene and the film lacks a “third layer” containing HDPE.

TABLE 5
Structure Details of the Unoriented Multilayer
Film of Comparative Example 3

| | Thickness as a | |
|---|---|---|
| Order of | % of Overall | |
| Layers | Film Thickness | Layer Contents |
| 1 | 20% | 90% COC having Tg of 78° C., 10% |
| | | 0.918 g/cm3 LLDPE |
| 2 | 10% | 100% 0.918 g/cm³ LLDPE |
| 3 | 8% | 100% tie resin |
| 4 | 11.5% | 100% EVOH |
| 5 | 8% | 100% tie resin |
| 6 | 42.5% | 50% 5% EVA, 50% LLDPE |

Comparative Example 4 is a metalized 1 mil (25.4 micron) MDOPE film having a general structure of HDPE/HDPE-mLLDPE/LMDPE/HDPE-mLLDPE/HDPE. The MDOPE film had been oriented in the machine direction at a ratio of 5.0 to 1.

TABLE 6
Comparison of MVTR of Metalized Films

| | | MVTR measured at 100° |
|---|---|---|
| | Optical | F. and 90% Rh, according |
| Film Sample | Density | to ASTM F1249 |
| Metalized Unoriented Multilayer | 3.8 | 0.107 g/m2/day |
| Film of Example 1 (unlaminated) | | |
| Metalized Unoriented Multilayer | 3.4 | 0.156 g/m2/day |
| Film of Example 2 (unlaminated) | | |
| Comparative Example 3 | 3.9 | 0.275 g/m2/day |
| Comparative Example 4 | 3.0 | 5.6 g/m2/day |

### EMBODIMENTS

Embodiment A. A recyclable packaging film comprising:
an unoriented multilayer film comprising:
a first surface comprising a first layer comprising a polymer selected from the group consisting of a cyclic olefin copolymer, an ethylene vinyl alcohol copolymer or a polyamide, the first layer having a thickness in a range of from 5% to 15% of a thickness of the unoriented multilayer film,
a second layer comprising a polyethylene having a density in a range of from 0.89 g/cm³ to 0.94 g/cm³, the second layer directly adjacent to the first layer, the second layer having a thickness in a range of from 5 to 60% of the thickness of the unoriented multilayer film, and
a third layer comprising a high-density polyethylene, the third layer directly adjacent to the second layer, the third layer having a thickness in a range of from 15% to 75% of the thickness of the unoriented multilayer film,
a vapor deposited layer located on the first surface; and
a total composition including greater than 90% polyethylene-based polymers, by weight.

Embodiment B. The recyclable packaging film according to Embodiment A wherein the unoriented multilayer film further comprises a second surface opposite the first surface, the second surface comprising a fourth layer comprising a polyethylene polymer.

Embodiment C. The recyclable packaging film according to Embodiment A or B further comprising a sealing layer attached to the unoriented multilayer film.

Embodiment D. The recyclable packaging film according to Embodiment C wherein the sealing layer is patterned.

Embodiment E. The recyclable packaging film according to any of Embodiments A through D wherein the vapor deposited layer comprises a metal and the recyclable packaging film has an optical density in a range of from 1.5 to 4.5, measured by ASTM D1003.

Embodiment F. The recyclable packaging film according to any of Embodiments A through D wherein the vapor deposited layer comprises an inorganic oxide.

Embodiment G. The recyclable packaging film according to any of Embodiments A through F wherein the first layer comprises in a range of from 90% to 100% of the cyclic olefin copolymer, the ethylene vinyl alcohol copolymer or the polyamide, by weight.

Embodiment H. The recyclable packaging film according to any of Embodiments A through G wherein the polymer of the first layer is fully amorphous.

Embodiment I. The recyclable packaging film according to any of Embodiments A through H wherein the polymer of the first layer is a cyclic olefin copolymer comprising a glass transition temperature in a range of from 60° C. to 180° C. or from 60° C. to 140° C.

Embodiment J. The recyclable packaging film according to any of Embodiments A through I wherein the first layer is free from particulates.

Embodiment K. The recyclable packaging film according to any of Embodiments A through J wherein the first layer is free from polyethylene polymers.

Embodiment L. The recyclable packaging film according to any of Embodiments A through K wherein the polyethylene comprised in the second layer has a density in a range of from 0.910 g/cm³ to 0.940 g/cm³.

Embodiment M. The recyclable packaging film according to any of Embodiments A through L wherein the third layer comprises in a range of from 90% to 100% high density polyethylene, by weight.

Embodiment N. The recyclable packaging film according to any of Embodiments A through M wherein the high-density polyethylene is bimodal with regard to molecular weight.

Embodiment O. The recyclable packaging film according to any of Embodiments A through N wherein the high-density polyethylene has a melt flow rate greater than 1 g/10 min, as measure ASTM D1238-10.

Embodiment P. The recyclable packaging film according to any of Embodiments A through O wherein the high-density polyethylene is nucleated.

Embodiment Q. The recyclable packaging film according to any of Embodiments A through P wherein the total composition includes a non-polyethylene content in a range of from 5% to 15%, by weight.

Embodiment R. The recyclable packaging film according to any of Embodiment A through Q further comprising a curl of less than 90%, according to the X-Cut Curl Test.

Embodiment S. The recyclable packaging film according to any of Embodiments A through R further comprising an oriented polyethylene-based film attached to the vapor deposited layer of the unoriented multilayer film.

Embodiment T. A recyclable packaging film comprising:
an unoriented multilayer film comprising:
a first surface comprising a first layer comprising 100% of a cyclic olefin copolymer, by weight, the first layer having a thickness in a range of from 5% to 15% of a thickness of the unoriented multilayer film,
a second layer comprising a polyethylene having a density in a range of from 0.89 g/cm³ to 0.94 g/cm³, the second layer directly adjacent to the first layer, the second layer having a thickness in a range of from 5 to 30% of the thickness of the unoriented multilayer film, and
a third layer comprising greater than 95% of a high-density polyethylene by weight, the third layer directly adjacent to the second layer, the third layer having a thickness in a range of from 50% to 75% of the thickness of the unoriented multilayer film,
a vapor deposited layer located on the first surface,
an oriented polyethylene film attached to the vapor deposited layer,
a patterned sealing layer attached to the unoriented multilayer film on a second surface, the second surface opposite of the first surface, and
a total composition including greater than 90% polyethylene-based polymers, by weight.

Embodiment U. A recyclable packaging film comprising:
an unoriented multilayer film comprising:
a first surface comprising a first layer comprising 100% of a cyclic olefin copolymer, by weight, the first layer having a thickness in a range of from 5% to 15% of a thickness of the unoriented multilayer film,
a second layer comprising a polyethylene having a density in a range of from 0.89 g/cm³ to 0.94 g/cm³, the second layer directly adjacent to the first layer, the second layer having a thickness in a range of from 40 to 60% of the thickness of the unoriented multilayer film, and
a third layer comprising greater than 95% of a high-density polyethylene by weight, the third layer directly adjacent to the second layer, the third layer having a thickness in a range of from 15% to 45% of the thickness of the unoriented multilayer film,
a vapor deposited layer located on the first surface,
an oriented polyethylene film attached to the vapor deposited layer,
sealing layer attached to the unoriented multilayer film on a second surface, the second surface opposite of the first surface, and
a total composition including greater than 90% polyethylene-based polymers, by weight.

Embodiment V. A package comprising a recyclable packaging film according to any of Embodiments A through U.

What is claimed is:

1. A recyclable packaging film comprising:
an unoriented multilayer film comprising:
a first surface comprising a first layer comprising a polymer selected from the group consisting of a cyclic olefin copolymer, an ethylene vinyl alcohol copolymer or a polyamide, the first layer having a thickness in a range of from 5% to 15% of a thickness of the unoriented multilayer film,
a second layer comprising a polyethylene having a density in a range of from 0.89 g/cm³ to 0.94 g/cm³, the second layer directly adjacent to the first layer, the second layer having a thickness in a range of from 5 to 60% of the thickness of the unoriented multilayer film, and
a third layer comprising a high-density polyethylene, the third layer directly adjacent to the second layer, the third layer having a thickness in a range of from 15% to 75% of the thickness of the unoriented multilayer film,
a vapor deposited layer located on the first surface; and
a total composition including greater than 90% polyethylene-based polymers, by weight.

2. The recyclable packaging film according to claim 1 wherein the unoriented multilayer film further comprises a second surface opposite the first surface, the second surface comprising a fourth layer comprising a polyethylene polymer.

3. The recyclable packaging film according to claim 1 further comprising a sealing layer attached to the unoriented multilayer film.

4. The recyclable packaging film according to claim 3 wherein the sealing layer is patterned.

5. The recyclable packaging film according to claim 1 wherein the vapor deposited layer comprises a metal and the recyclable packaging film has an optical density in a range of from 1.5 to 4.5, measured by ASTM D1003.

6. The recyclable packaging film according to claim 1 wherein the vapor deposited layer comprises an inorganic oxide.

7. The recyclable packaging film according to claim 1 wherein the first layer comprises in a range of from 90% to 100% of the cyclic olefin copolymer, the ethylene vinyl alcohol copolymer or the polyamide, by weight.

8. The recyclable packaging film according to claim 1 wherein the polymer of the first layer is fully amorphous.

9. The recyclable packaging film according to claim 1 wherein the polymer of the first layer is a cyclic olefin copolymer comprising a glass transition temperature in a range of from 60° C. to 180° C.

10. The recyclable packaging film according to claim 1 wherein the first layer is free from particulates.

11. The recyclable packaging film according to claim 1 wherein the first layer is free from polyethylene polymers.

12. The recyclable packaging film according to claim 1 wherein the polyethylene comprised in the second layer has a density in a range of from 0.910 g/cm³ to 0.940 g/cm³.

13. The recyclable packaging film according to claim 1 wherein the third layer comprises in a range of from 90% to 100% high density polyethylene, by weight.

14. The recyclable packaging film according to claim 1 wherein the high-density polyethylene is bimodal with regard to molecular weight.

15. The recyclable packaging film according to claim 1 wherein the high-density polyethylene has a melt flow rate greater than 1 g/10 min, as measure ASTM D1238-10.

16. The recyclable packaging film according to claim 1 wherein the high-density polyethylene is nucleated.

17. The recyclable packaging film according to claim 1 wherein the total composition includes a non-polyethylene content in a range of from 5% to 15%, by weight.

18. The recyclable packaging film according to claim 1 further comprising a curl of less than 90%, according to the X-Cut Curl Test.

19. The recyclable packaging film according to claim 1 further comprising an oriented polyethylene-based film attached to the vapor deposited layer of the unoriented multilayer film.

20. A recyclable packaging film comprising:
an unoriented multilayer film comprising:
a first surface comprising a first layer comprising 100% of a cyclic olefin copolymer, by weight, the first layer having a thickness in a range of from 5% to 15% of a thickness of the unoriented multilayer film,
a second layer comprising a polyethylene having a density in a range of from 0.89 g/cm³ to 0.94 g/cm³, the second layer directly adjacent to the first layer, the second layer having a thickness in a range of from 5 to 30% of the thickness of the unoriented multilayer film, and
a third layer comprising greater than 95% of a high-density polyethylene by weight, the third layer directly adjacent to the second layer, the third layer having a thickness in a range of from 50% to 75% of the thickness of the unoriented multilayer film,
a vapor deposited layer located on the first surface,
an oriented polyethylene film attached to the vapor deposited layer,
a patterned sealing layer attached to the unoriented multilayer film on a second surface, the second surface opposite of the first surface, and
a total composition including greater than 90% polyethylene-based polymers, by weight.

21. A recyclable packaging film comprising:
an unoriented multilayer film comprising:
a first surface comprising a first layer comprising 100% of a cyclic olefin copolymer, by weight, the first layer having a thickness in a range of from 5% to 15% of a thickness of the unoriented multilayer film,
a second layer comprising a polyethylene having a density in a range of from 0.89 g/cm³ to 0.94 g/cm³, the second layer directly adjacent to the first layer, the second layer having a thickness in a range of from 40 to 60% of the thickness of the unoriented multilayer film, and
a third layer comprising greater than 95% of a high-density polyethylene by weight, the third layer directly adjacent to the second layer, the third layer having a thickness in a range of from 15% to 45% of the thickness of the unoriented multilayer film,
a vapor deposited layer located on the first surface,
an oriented polyethylene film attached to the vapor deposited layer,
sealing layer attached to the unoriented multilayer film on a second surface, the second surface opposite of the first surface, and
a total composition including greater than 90% polyethylene-based polymers, by weight.

22. A package comprising a recyclable packaging film according to claim 3.
